(19) United States
(12) Patent Application Publication
(10) Pub. No.: US 2012/0120219 A1
(43) Pub. Date: May 17, 2012

(54) ELECTRONIC DEVICE AND EMOTION MANAGEMENT METHOD USING THE SAME

(75) Inventor: CHO-HAO WANG, Tu-Cheng (TW)

(73) Assignee: HON HAI PRECISION INDUSTRY CO., LTD., Tu-Cheng (TW)

(21) Appl. No.: 13/167,709

(22) Filed: Jun. 24, 2011

(30) Foreign Application Priority Data
Nov. 15, 2010 (TW) 99139254

(51) Int. Cl. H04N 7/18; G06K 9/00

(52) U.S. Cl. 348/77; 382/128; 348/E07.085

(57) ABSTRACT

An electronic device and emotion management method includes presetting emotion classifications having different facial expression features, and presetting a relaxation method corresponding to each of the emotion classifications. Original characteristic values of facial expression features of each of the emotion classifications are stored in a storage device. An image is acquired using a camera module. Expression characteristic values of a human face of a recognized person in the image are acquired to determine an emotion classification of the determined expression characteristic values. A relaxation method corresponding to the determined emotion classification is executed to calm the recognized person.

### BACKGROUND

1. Technical Field

Embodiments of the present disclosure relate to biological recognition technology, and more particularly to an electronic device and emotion management method using the electronic device.

2. Description of Related Art

Facial recognition technology is widely used, for example, a security surveillance system may utilize the facial recognition technology to recognize people in a monitored situation. The facial recognition technology may be used to carry out more precise and specific functions. Thus, an electronic device and emotion management method making use of the facial recognition is desired.

### BRIEF DESCRIPTION OF THE DRAWINGS

FIG. 1 is a block diagram of one embodiment of an electronic device.

FIG. 2 is a schematic diagram of one embodiment of an emotion classification.

FIG. 3 is a flowchart of one embodiment of an emotion management method using the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives

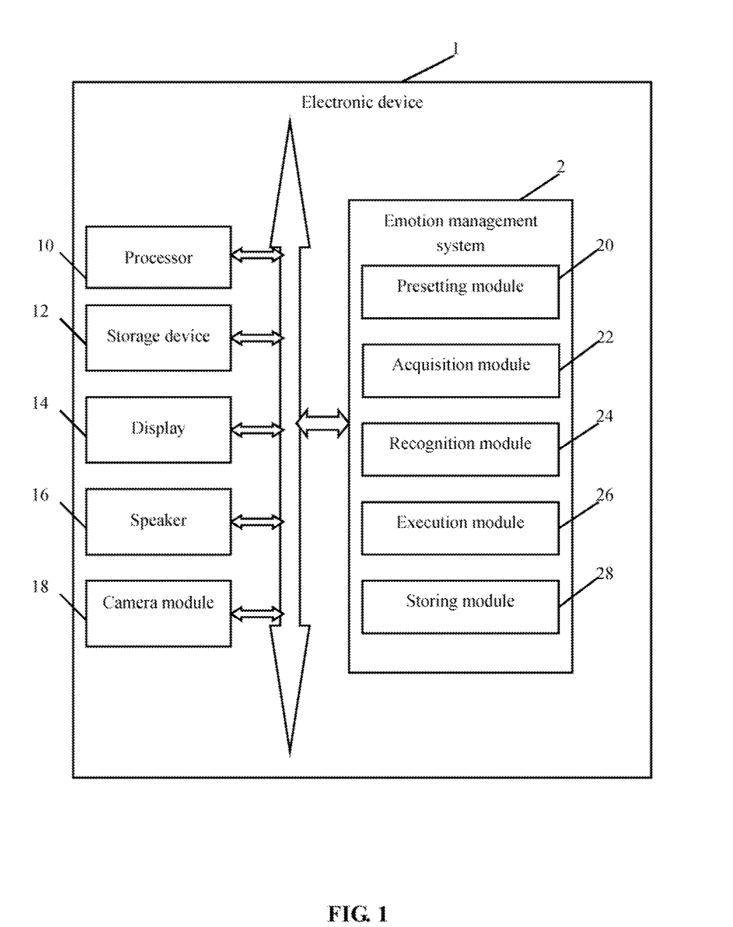

FIG. 1 is a block diagram of one embodiment of an electronic device 1. The electronic device 1 includes an emotion management system 2. The emotion management system 2 may be used to recognize facial features of a human face in an image, determine a human emotion according to the facial features, and execute a preset relaxation method to counteract the human emotion to calm or settle a person. For example, the emotion management system 2 may play soft music when the human emotion is determined to be anger. Detailed descriptions are provided below.

In some embodiments, the electronic device 1 may be a computer, a notebook computer, a computer server, a communication device (e.g., a mobile phone), a personal digital assistant, or any other computing device. The electronic device 1 also includes at least one processor 10, a storage device 12, a display 14, a speaker 16, and at least one camera module 18. The at least one processor 10 executes one or more computerized operations of the electronic device 1 and other applications, to provide functions of the electronic device 1. The storage device 12 stores one or more programs, such as programs of the operating system, other applications of the electronic device 1, and various kinds of data, such as images, music, and videos. In some embodiments, the storage device 12 may include a memory of the electronic device 1 and/or an external storage card, such as a memory stick, a smart media card, a compact flash card, or any other type of memory card.

The at least one camera module 18 may capture images. In some embodiments, the camera module 18 may be a webcam to capture images or videos of a specific scene, such as a factory. The display 14 may display visible data, such as the images captured by the camera module 18. The speaker 16 may output sounds such as the music.

In some embodiments, the management system 2 includes a presetting module 20, an acquisition module 22, a recognition module 24, an execution module 26, and a storing module 28. The modules 20, 22, 24, 26 and 28 may include computerized codes in the form of one or more programs stored in the storage device 12. The computerized codes include instructions executed by the at least one processor 10 to provide functions for modules 20, 22, 24, 26 and 28. Details of these functions follow.

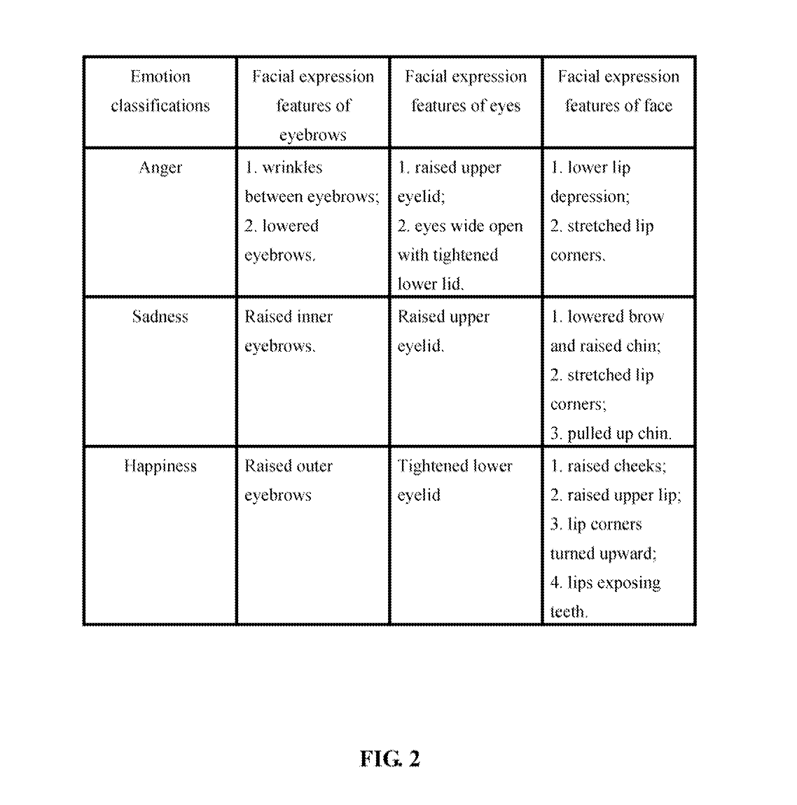

The presetting module 20 presets emotion classifications having different facial expression features, and presets a relaxation method corresponding to each of the emotion classifications. The emotion classifications may include, but are not limited to, happiness, sadness, fear, anger, and surprise. For example, as shown in FIG. 2, facial expression features of the emotion classification of “sadness” may include raised inner eyebrows, raised eyelids, lowered brow, raised chin, and/or pulled up chin. In some embodiments, the relation method may be used to counteract human emotion to calm, settle or ease a person. In other embodiments, the relation method also may be used to encourage the human emotion under the condition that the emotion classification of the person is happiness.

The relaxation methods may include, but are not limited to, playing preset music using the speaker 16, playing a preset video using the display 14 and the speaker 16, displaying preset images on the display 14, and/or sending a predetermined message to a specific user according to each emotion classification. For example, the emotion management system 2 may play soft music when a human emotion of a specific person is determined to be anger, display landscape photos on the display 14, and/or send a message (e.g., “Please calm down, everything will be ok.”) to counteract the human emotion or ease the specific person. The preset music, video, images, and/or message are predetermined by the presetting module 20.

It should be noted that, all of the facial expression features shown in FIG. 2 are merely examples to assist in describing the embodiments. The presetting of the emotion classifications, the facial expression features of each emotion classification, and the relaxation method corresponding to each emotion classification may be modified, added, or canceled according to user requirements.

In some embodiments, before the emotion management system 2 is used to recognize human faces and determine human emotions, original characteristic values of the facial expression features of each of the emotion classifications need to be determined and stored.

As mentioned above, the emotion classifications have different facial expression features. The facial expression features may include, but are not limited to, grayscale features, motion features, and frequency features. For example, the original characteristic values of the gray scale features may be the gray scale values of different facial expression features. The original characteristic values of the motion features may be motion information of predetermined facial features of different facial expression features. For example, the predetermined facial features, such as eyes, eyebrows, the nose, the eyelids, lips, and cheeks.

The storing module 28 stores the original characteristic values of different facial expression features of each of the emotion classifications in the storage device 12. In some embodiments, the original characteristic values may be acquired by recognizing specific persons (e.g., authorized users) in a specific location (e.g., a warehouse, a factory), or non-specific persons. If the original characteristic values are acquired from specific persons, the storing module 28 further records and stores usernames and contact information corresponding to the original characteristic values, which have been stored.

The acquisition module 22 acquires an image using the camera module 18. The acquisition module 22 also may acquire a video using the camera module 18, to acquire one or more images from the video in sequence. The emotion management system 2 may recognize changes of the facial expression features from the images.

The recognition module 24 determines expression characteristic values of a human face in the image. In detail, the recognition module 24 locates and recognizes the human face in the image, for example, utilizing a human face frontal view detection method to recognize the human face. The recognition module 24 extracts the facial features from the recognized human face, and recognizes facial expression features according to the facial features. Then the recognition module 24 determines the expression characteristic values of the recognized facial expression features. In some embodiments, the facial features may be recognized using a point distribution model and a gray-level model, and the facial expression features are recognized using Gabor wavelet transformation, or active shape model (ASM), for example.

The recognition module 24 further determines an emotion classification relating to the determined expression characteristic values by comparing the determined expression characteristic values with the original characteristic values in the storage device 12.

The execution module 26 executes a relaxation method corresponding to the determined emotion classification, to calm or ease a recognized person in the image. As mentioned above, the execution module 26 may play the preset music or video, display the preset images, and/or send the preset message to the recognized person in the image.

In addition, if the original characteristic values in the storage device 12 are acquired based on the specific persons, the recognition module 24 may further determine a corresponding username of the recognized person in the image, and record the determined emotion classification and the username of the recognized person in the storage device 12.

In other embodiments, the presetting module 20 is further operable to preset different emotion degrees or levels in each of the emotion classifications, such as a light, middle, and heavy. The presetting module 20 may further preset a relaxation method corresponding to each of the emotion degrees in each of the emotion classifications. According to the more detailed presetting of the emotion degrees, the emotion management system 2 may classify the recognized facial expression features into an emotion degree in one of the emotion classifications. For example, the emotion classification of the recognized person may be classified as happiness, and the emotion degree in the recognized person may be “heavy”. That is to say, the emotion of the recognized person is determined to be exultant by the emotion management system 2.

In some embodiments, the emotion management system 2 may be used in a factory to detect emotions of workers in the factory, and execute corresponding relaxation methods to calm or ease the emotions of the workers.

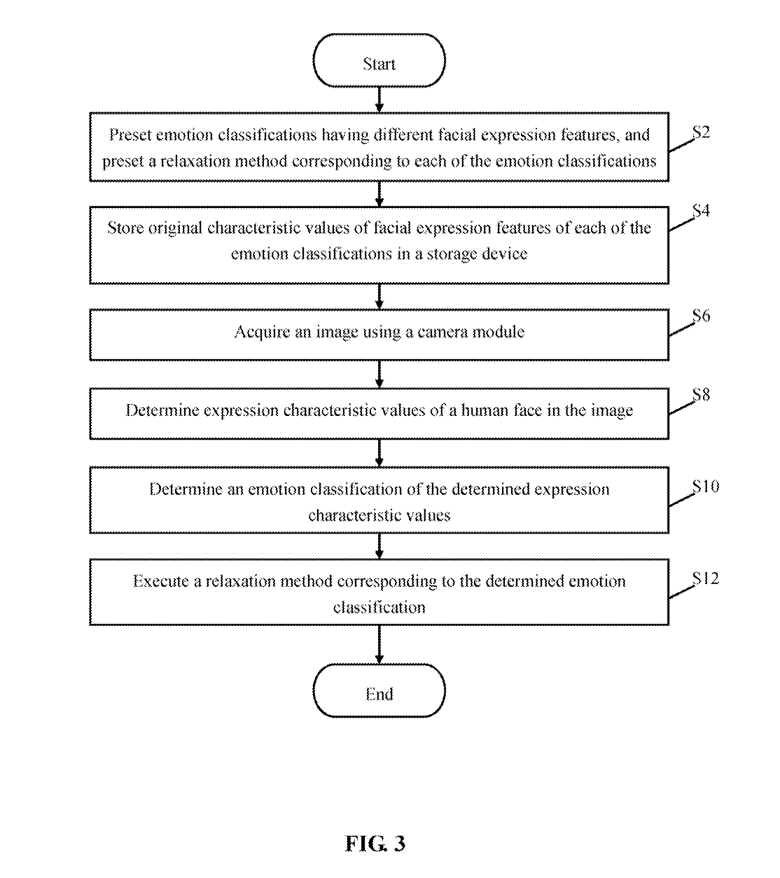

FIG. 3 is a flowchart of an emotion management method using the electronic device 1 of FIG. 2. Depending on the embodiment, additional blocks may be added, others removed, and the ordering of the blocks may be replaced.

In block S2, the presetting module 20 presets emotion classifications according to different facial expression features, and presets a relaxation method corresponding to each of the emotion classifications. As mentioned above, the emotion classifications may include happiness, sadness, fear, anger, and surprise. The relaxation methods may include playing preset music using the speaker 16, playing a preset video using the display 14 and the speaker 16, displaying preset images on the display 14, and/or sending a predetermined message corresponding to each determined emotion to a specific user.

In block S4, the storing module 28 stores original characteristic values of the facial expression features of each of the emotion classifications in the storage device 12.

In block S6, the acquisition module 22 acquires an image using the camera module 18.

In block S8, the recognition module 24 determines expression characteristic values of a human face in the image. As mentioned above, the recognition module 24 firstly locates and recognizes the human face in the image firstly. The recognition module 24 extracts the facial features from the recognized human face, and recognizes facial expression features according to the facial features. Then the recognition module 24 determines the expression characteristic values of the recognized facial expression features.

In block S10, the recognition module 24 determines an emotion classification of the determined expression characteristic values by comparing the determined expression characteristic values with the original characteristic values in the storage device 12.

In block S12, the execution module 26 executes a relaxation method corresponding to the determined emotion classification, to calm or ease a recognized person in the image.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An emotion management method using an electronic device, the electronic device comprising a camera module and a storage device, the emotion management method comprising:
presetting emotion classifications having different facial expression features, and presetting a relaxation method corresponding to each of the emotion classifications;
storing original characteristic values of facial expression features of each of the emotion classifications in the storage device;
acquiring an image using the camera module;
determining expression characteristic values of a human face in the image;
determining an emotion classification of the determined expression characteristic values by comparing the determined expression characteristic values with the original characteristic values in the storage device; and
executing a relaxation method corresponding to the determined emotion classification.

2. The emotion management method according to claim 1, wherein the relaxation method comprises playing preset music using a speaker of the electronic device, playing preset video using a display and the speaker of the electronic device, and/or displaying preset images on the display.

3. The emotion management method according to claim 1, wherein the step of determining expression characteristic values of a human face in the image comprising. recognizing the human face in the image;
extracting facial features from the recognized human face;
recognizing facial expression features according to the facial features; and
determining the expression characteristic values of the recognized facial expression features.

4. The emotion management method according to claim 3, wherein the facial expression features comprise gray scale features, motion features, and frequency features.

5. The emotion management method according to claim 1, further comprising:
presetting emotion degrees in each of the emotion classifications; and
presetting a relaxation method corresponding to each of the emotion degrees in each of the emotion classifications.

6. The emotion management method according to claim 5, wherein the emotion degrees in each of the emotion classifications comprise light, middle, and heavy.

7. An electronic device, the electronic device comprising:
a camera module;
a storage device;
at least one processor; and
one or more programs stored in the storage device and being executable by the at least one processor, the one or more programs comprising:
a presetting module operable to preset emotion classifications having different facial expression features, and preset a relaxation method corresponding to each of the emotion classifications;
a storing module operable to store original characteristic values of facial expression features of each of the emotion classifications in the storage device;
an acquisition module operable to acquire an image using the camera module;
a recognition module operable to determine expression characteristic values of a human face in the image, and determine an emotion classification of the determined expression characteristic values by comparing the determined expression characteristic values with the original characteristic values in the storage device; and
an execution module operable to execute a relaxation method corresponding to the determined emotion classification.

8. The electronic device according to claim 7, wherein the relaxation method comprises playing preset music using a speaker of the electronic device, playing preset video using a display and the speaker of the electronic device, and/or displaying preset images on the display.

9. The electronic device according to claim 7, wherein the recognition module determines the expression characteristic values of the human face in the image by:
recognizing the human face in the image;
extracting facial features from the recognized human face;
recognizing facial expression features according to the facial features; and
determining the expression characteristic values of the recognized facial expression features.

10. The electronic device according to claim 9, wherein the facial expression features comprise gray scale features, motion features, and frequency features.

11. The electronic device according to claim 7, wherein the presetting module is further operable to preset emotion degrees in each of the emotion classifications, and preset a relaxation method corresponding to each of the emotion degrees in each of the emotion classifications.

12. The electronic device according to claim 11, wherein the emotion degrees in each of the emotion classifications comprise light, middle, and heavy.

13. A non-transitory storage medium storing a set of instructions, the set of instructions capable of being executed by a processor to perform an emotion management method using an electronic device, the electronic device comprising a camera module and a storage device, the emotion management method comprising:
presetting emotion classifications having different facial expression features, and presetting a relaxation method corresponding to each of the emotion classifications;
storing original characteristic values of facial expression features of each of the emotion classifications in the storage device;
acquiring an image using the camera module;
determining expression characteristic values of a human face in the image;
determining an emotion classification of the determined expression characteristic values by comparing the determined expression characteristic values with the original characteristic values in the storage device; and
executing a relaxation method corresponding to the determined emotion classification.

14. The storage medium as claimed in claim 13, wherein the relaxation method comprises playing preset music using a speaker of the electronic device, playing preset video using a display and the speaker of the electronic device, and/or displaying preset images on the display.

15. The storage medium as claimed in claim 13, wherein the step of determining expression characteristic values of a human face in the image comprising. recognizing the human face in the image;
extracting facial features from the recognized human face;
recognizing facial expression features according to the facial features; and
determining the expression characteristic values of the recognized facial expression features.

16. The storage medium as claimed in claim 15, wherein the facial expression features comprise gray scale features, motion features, and frequency features.

17. The storage medium as claimed in claim 13, wherein the emotion management method further comprises:
presetting emotion degrees in each of the emotion classifications; and
presetting a relaxation method corresponding to each of the emotion degrees in each of the emotion classifications.

18. The storage medium as claimed in claim 17, wherein the emotion degrees in each of the emotion classifications comprise light, middle, and heavy.
